(19) United States
(12) Patent Application Publication
(10) Pub. No.: US 2026/0276114 A1
(43) Pub. Date: Sep. 17, 2026

(54) TUBE SWAGE PROCESS AND SYSTEM WITH ROTATABLE TUBE JOINT

(71) Applicant: Steven FRITZE, Marietta, GA (US)

(72) Inventor: Steven FRITZE, Marietta, GA (US)

(21) Appl. No.: 19/669,713

(22) Filed: May 6, 2026

Related U.S. Application Data
(63) Continuation-in-part of application No. 18/350,466, filed on Jul. 11, 2023.

(51) Int. Cl. F16L 13/14; F16L 21/00

(52) U.S. Cl. CPC F16L 13/141; F16L 21/002

(57) ABSTRACT

A connector creates a connection between one or more tubes swaged with a swaging tool and the connector, allowing in-place modifications to allow connection between the tubes and the connector. The swaging tool creates one or more annular bosses in the tubes which engage corresponding annular square cut grooves of the connector with 90 degree square corners to permanently connect one or more tubes. Voids are formed between parts of a surface of the first annular boss and parts of a surface of the first annular square cut groove. The tubes are rotatable about the connector, and the connector can be rotatable about the tubes. Optional through-holes in the connector allow wiring, fluids, or other materials to pass through and be protected by the swage tube assembly. Multiple clamping, threaded and pivoting connection variants are possible.

This application claims priority to U.S. patent application Ser. No. 18/350,466, “TUBE SWAGE PROCESS AND SYSTEM,” filed Jul. 11, 2023, in the United States Patent and Trademark Office, the application by the same inventive entity, with the entirety of said application being incorporated herein by reference to provide continuity of disclosure.

### 1. FIELD OF THE INVENTION

The present invention, titled TUBE SWAGE PROCESS AND SYSTEM With Rotatable Tube Joint, but referred to for brevity as the “Tube Swage,” or “Tool Swage System,” hereafter, relates to a process and system for swaging (expanding and/or contracting by means of mechanical force) tubes to allow them to be easily and reliably connected without external retention, and provide the ability for the tube to freely rotate after assembly.

### 2. DESCRIPTION OF THE RELATED ART

Tube swage systems are known in the art: swaging the end of a tube by either expanding it or contracting it so it will surround or fit inside the end of a second tube, allowing them to be connected communicably, is a standard process in many fields. However, such connections are not mechanically solid: some sort of glue, clamp, set screw, or other means of forcing the swaged tubes and to stay in place to avoid mechanical failure and/or leakage of fluids conducted through the tubes are necessary. This adds expense and additional points of failure to such connections. It would be useful to be able to link swaged tubes together in a fashion which is mechanically stable and provides reasonable integrity to the common communicable space of the linked tubes.

Furthermore, in some cases it is necessary to swage tubes together as an assembly with requirements for hingeable components.

The present invention addresses these concerns.

### SUMMARY OF THE INVENTION

Aspects of the present invention provide a Tube Swage Process and System With Rotatable Tube Joint which allows tubes to be modified by swaging to allow a mechanically stable joining having reasonable integrity without the use of external retention means such as clamps or set screws, and allow for the tubes to freely rotate after assembly.

Aspects of the present invention allow tubes to be modified by swaging in the field with a simple and reliable process.

The present invention further provides a process and system for creating useful assemblies with tubes and connectors.

According to an aspect of the present invention, a tube swage system comprises a first tube having a first outer wall and a first annular boss extending from a first inner wall of the first tube; and a connector fitting having a first annular square cut groove with 90 degree square edges, the first annular square cut groove mechanically engaging with the first annular boss, wherein voids are formed between parts of a surface of the first annular boss and parts of a surface of the first annular square cut groove.

According to another aspect of the represent invention, an assembly comprises a plurality of tubes each having an outer wall and an annular boss extending from an inner wall of the tube; and a plurality of connector fittings each having an annular square cut groove with 90 degree square edges; wherein the square cut groove of each of the plurality of connector fittings mechanically engages with the annular boss of one of the plurality of tubes; wherein voids are formed between parts of a surface of each annular boss and parts of a surface of a corresponding one of the annular square cut grooves.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a perspective view of an embodiment of the invention in use.

FIG. 2A is a perspective view of the invention in use. FIG. 2B shows the connector fitting 20 shown in FIG. 2A.

FIG. 3A shows a cutaway view of a joint made possible by the invention. FIG. 3B shows an exploded view of the left side of FIG. 3A. FIG. 3C shows a view of a connector fitting and two tubes connected to the connector fitting after assembly shown in FIG. 3A.

FIG. 3D shows a cutaway view of an optional variant of a joint made possible by the invention. FIG. 3E shows an exploded view of the left side of FIG. 3D.

FIG. 4 is a cutaway view of a swaging tool 10a deforming the walls of tubes 11 & 16 to create outer swaged rings 14 and inner swaged annular bosses 34 into the square cut annular grooves 24 of an optional variant 40 connector fitting.

FIG. 5A is a top view of a swaging configuration of the tool, and FIG. 5B is a side view of a cutting configuration (related art).

FIG. 6 is a side view including a swaging tool of a first optional variant on the invention.

FIG. 7A is a side view of a second optional variant on the invention.

FIG. 7B is a cross-sectional view including a swaging tool according to second optional variant on the invention.

FIG. 8 is a perspective view of a third optional variant on the invention.

FIG. 9 is an exploded perspective view of the third optional variant on the invention.

FIGS. 10A and 10B are two different perspective views of a fourth optional variant on the invention.

FIGS. 11A-11D are perspective views of a first and second assembly incorporating a system and process of the invention.

FIGS. 12A and 12B are perspective views of a fifth optional variant on the invention.

FIGS. 13A-13E are perspective views of a sixth optional variant on the invention.

FIG. 14 is a perspective view of a seventh optional variant on the invention.

FIG. 15 is a perspective view of an eighth optional variant on the invention.

FIG. 16 is a perspective view of a ninth optional variant on the invention.

FIG. 17 is a perspective view of a second assembly incorporating a system and process of the invention.

FIG. 18 is a perspective view of a third assembly incorporating a system and process of the invention.

FIG. 19 is a perspective view of a fourth assembly incorporating a system and process of the invention.

FIG. 20 is a perspective view of a fifth assembly incorporating a system and process of the invention.

FIG. 21 is a perspective view of a sixth assembly incorporating a system and process of the invention.

FIG. 22 is a perspective view of a seventh assembly incorporating a system and process of the invention.

FIG. 23 is a perspective view of an eighth assembly incorporating a system and process of the invention.

FIG. 24 is a perspective view of a ninth assembly incorporating a system and process of the invention.

FIG. 25 is a perspective view of a tenth assembly incorporating a system and process of the invention.

FIG. 26 is a perspective view of an eleventh assembly incorporating a system and process of the invention showing the tenth assembly in structural form.

FIG. 27 is a perspective view showing a detail of the eleventh assembly.

### DETAILED DESCRIPTION OF THE EMBODIMENTS

Reference will now be made in detail to several embodiments of the invention that are illustrated in accompanying drawings. Whenever possible, the same or similar reference numerals are used in the drawings and the description to refer to the same or like parts or steps. The drawings are in simplified form and are not to precise scale. For purposes of convenience and clarity only, directional terms such as top, bottom, left, right, up, down, over, above, below, beneath, rear, and front, can be used with respect to the drawings. These and similar directional terms are not to be construed to limit the scope of the invention in any manner. The words attach, connect, couple, and similar terms with their inflectional morphemes do not necessarily denote direct or intermediate connections, but can also include connections through mediate elements or devices.

For purposes of this application, “tubes” refer to hollow cylindrical objects with walls which are swageable, meaning that if a radially-oriented force is exerted against the interior or exterior of the walls, they have sufficient elasticity to deform radially without breaking or otherwise being materially damaged or weakened, and sufficient rigidity that they will retain some or all of the imparted expansion, leaving the tube with a smaller inside diameter and likely a corresponding smaller outside diameter in the portion which was swaged. Tubes could include what are commonly called pipes, lines, hoses, etc. Tubes may or may not be air-tight, water-tight, opaque or non-opaque, etc. An embodiment will be described as powered by a human user, but could also be electrically, hydraulically, or pneumatically powered or powered by any other suitable means. The areas where tubes are joined together are generally referred to as “joints.”

It should be noted that an embodiment of the invention will also work with connector fittings which are not hollow. While applications of this type do not allow the motion of fluids or routing other materials through them, they are useful for structural and other purposes.

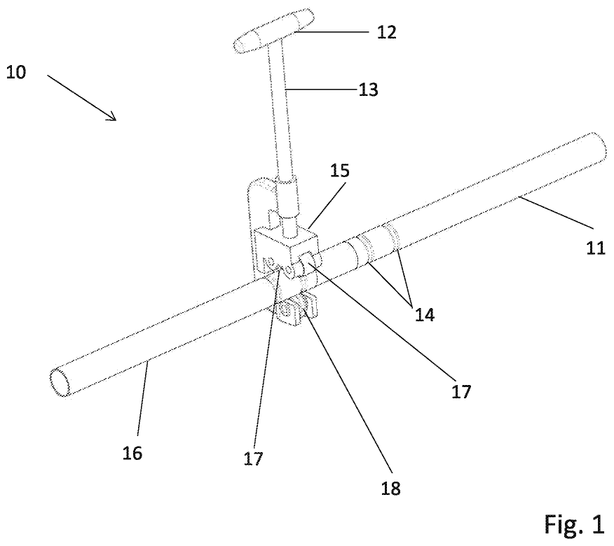

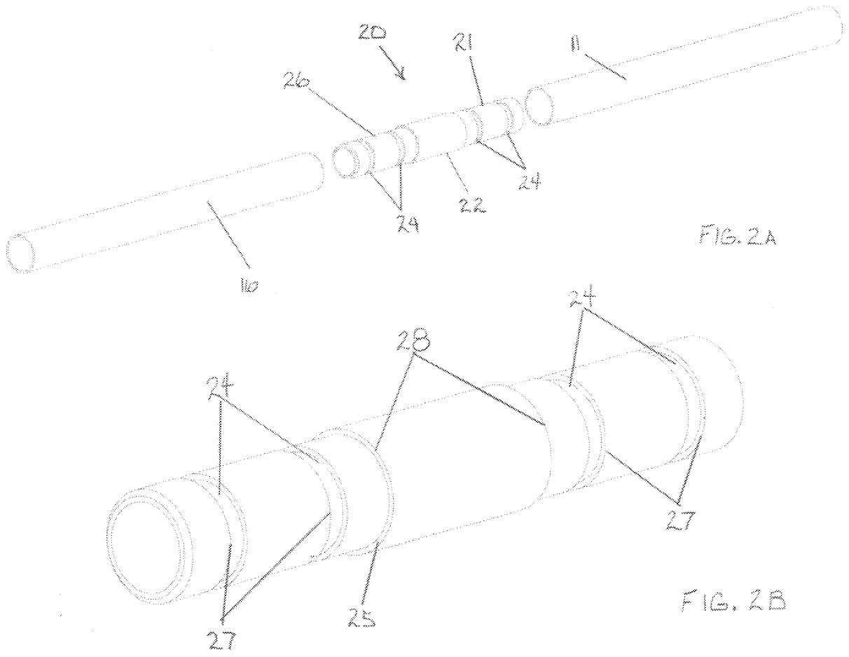

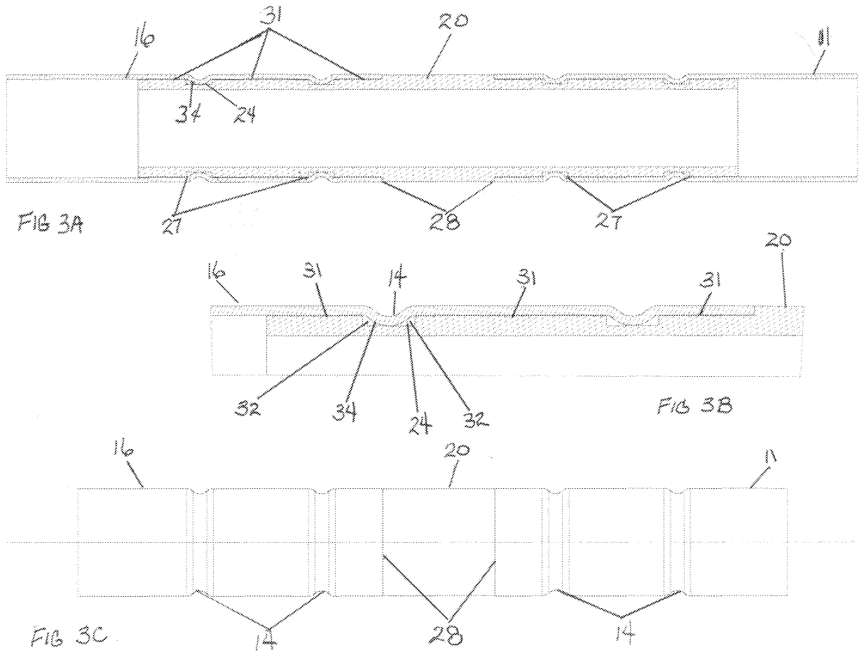

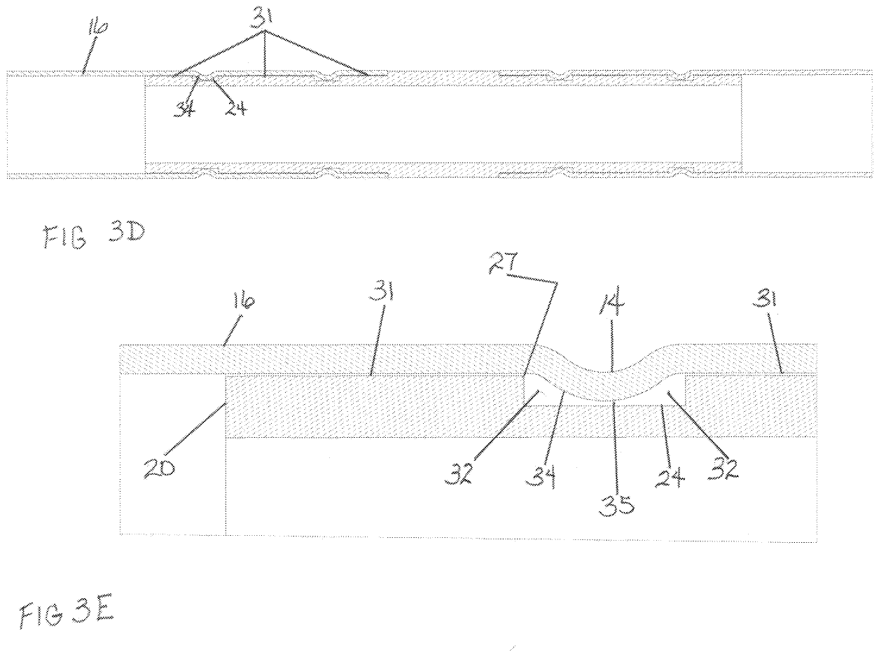

FIG. 1 shows first tube 11 and second tube 16, which are to be joined with a process of the invention. If a connector fitting 20 (see FIG. 2A) is swaged, cast, or otherwise manufactured with square cut annular grooves 24 as shown in FIGS. 2A, 2B,3A-3E (see also FIGS. 4, 7A, 7B, and 10-16), swaged annular bosses 34 of the tube 11 (also tube 16) allow the tubes11 and 16to rotate freely on the connector fitting 20 due to the greatly reduced contact area. To help decrease friction between tubes 11, 16, and connector fitting 20, a compound comprising a lubricant can be applied to annular cut grooves and connector ends 21 and 26 prior to installation of tubes 11 and 16. Application of grease or other similar compound will be retained in gaps31 and voids 32 as shown in FIGS. 3A, 3B, and between gaps 31, 35 & voids 32 as shown in FIGS. 3D, 3E, & 16. This addition of grease or other similar compound will allow better freedom of rotation at the swaged assembly.

Alternatively, to help increase friction between tubes 11, 16, and connector fitting 20, a compound comprising a sealant can be applied to annular cut grooves and connector ends 21 and 26 prior to installation of tubes 11 and 16. Application of sealant or other similar compound will be retained in gaps 31 and voids 32 as shown in FIG. 3A, and 3B, and between gaps 31, 35 & voids 32 as shown in FIGS. 3D & 3E. This addition of silicone or other similar compound will better restrict the freedom of rotation at the swaged assembly. Swaging tool 10 has handle 12 to be manipulated by a human user (not shown) which is connected to swage head 15 with connector 13. While connector 13 is shown connecting as a threaded rod, which can also be used to reduce the distance between the first and second support wheels 17 and a swaging wheel 18, it could be connected in any reasonable manner. Swage head 15 has the first and second support wheels 17 and swaging wheel 18. While it is preferred to have two support wheels, swage head 15 could incorporate any reasonable number of support wheels 17. The distance between support wheels 17 and swaging wheel 18 is adjusted either manually or automatically such that at the beginning of the process, and it is equal to or larger than the outside diameter of the tube 11 or tube 16to be swaged. Swaging tool 10 is rotated around the tube 11 or tube 16to be swaged, and the distance between support wheels 17 and swaging wheel 18 is gradually reduced. This results in swaging wheel 18 gradually compressing the tube to be swaged, producing swaged rings 14. It is optional, but not required, for swaging tool 10 to have multiple swaging wheels 18, offset axially such that it can create multiple swaged rings 14 simultaneously. It is likewise optional, but not required, for swaging tool 10 to have multiple support wheels 17 instead of a single support wheel 17. These options can be combined. Swaged rings 14 comprise an area of the tube having been swaged which has a smaller outside diameter and a corresponding smaller inside diameter, resulting in annular bosses 34 on the interior of the tubes 11 and 16 (see FIG. 3A-3E).

It is optional, but not required, that support wheels 17 be configured such that it is also a swaging wheel, such that the swaged rings are formed by both support wheels17 and swaging wheel 18 simultaneously. (See FIG. 4)

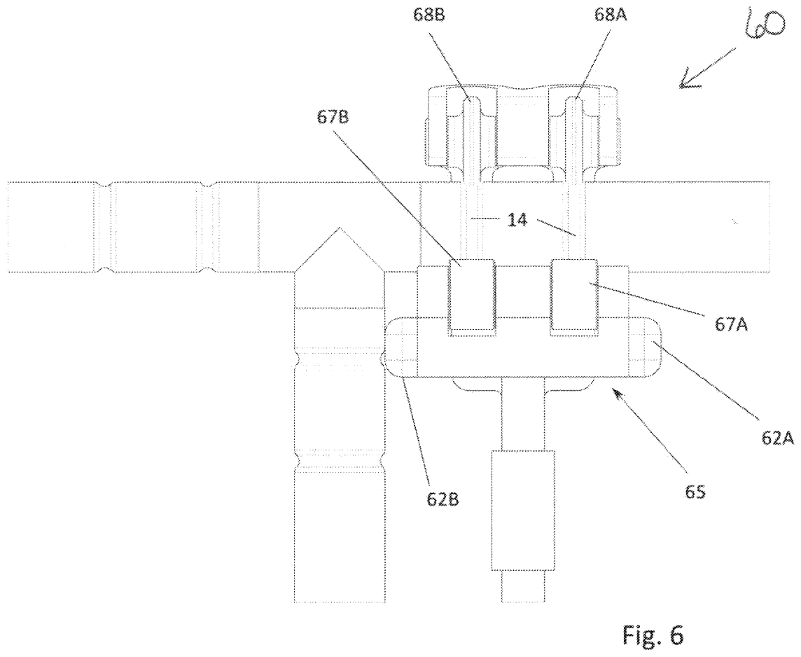

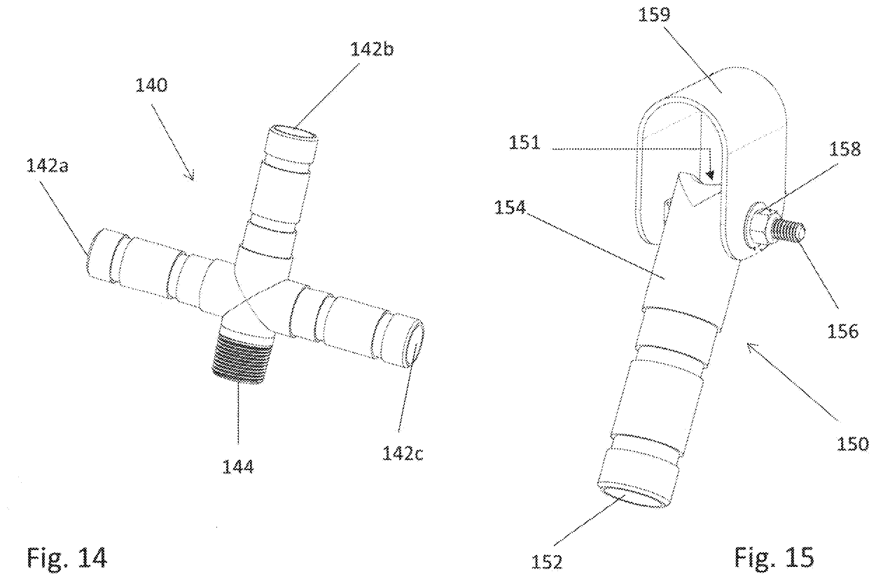

FIG. 2 shows a connector fitting 20, comprising body 22, first connector end 21, and second connector end 26. Both connector ends21 and 26 have one or more annular grooves 24, which can either be machined into the connector ends 21, 26 during manufacturing, or formed by casting the connector fitting 20at the time of manufacture. The outer 90 degree corners of grooves 24 define edge curves 27. These outer 90 degree corners of groove 24 help “trap” the inner annular bosses 34 after swaging and prevent the assembly from easily becoming disengaged. Considerable tension forces would need to be applied between the outer tubes and the connector fittings for the swage connection to be forcibly separated. Connector fitting 20 can be formed of any suitable material. The end face of the connector body 22 that joins each connector end provides a shoulder 25 for adjoining tubes. The outer 90 degree corner of shoulder 25 defines edge curves 28 that are used for reference when positioning the swaging tools 10or 60 at the beginning of each swage. If the tubing is required to have fluid integrity, it is preferred for the connector fitting 20 to incorporate feature 72 to insert O-ring 71 in order that the O-ring will press firmly against the inside surface of tubes 11 and 16. (see FIGS. 7A and 7B). To help increase fluid integrity between tubes 11, 16, and connector fitting 20, silicone or other similar compound can be applied to annular cut grooves and connector ends 21 and 26 prior to installation of tubes 11 and 16. Application of silicone or other similar compound will be retained in gaps31 and voids 32 as shown in FIGS. 3A, 3B, and 16. Similarly, application of silicone or other similar compound will be retained in gaps 31, 35, and voids 32 as shown in FIGS. 3D, 3E. Connector fitting 20 will connect first tube 11 and second tube 16 after swaging as shown in FIGS. 3A-3E, and 16.

Depending on the ultimate use of the assembled tubing, connector fitting 20 may be solid (increasing structural rigidity and strength) or hollow (enabling fluids, wiring, or any other desired media or object(s) to pass through the assembled tubing.)

FIG. 3A shows a cutaway view of a joint between the tubes 11, 16 and the connector fitting 20. FIG. 3B shows an exploded view of the left side of FIG. 3A. FIG. 3C shows a view of the connector fitting 20 along with both tubes 11 and 16 after swaging. FIG. 3D shows a cutaway view of a joint between the tubes 11, 16 and the connector fitting 20. FIG. 3E shows an exploded view of the left side of FIG. 3D.

In FIG. 3A-3B, first tube 11 and second tube 16 are joined by connector fitting 20. Annular bosses 34 formed in the tubes 11, and/or 16 by the swaging tool 10 (see FIGS. 1 and 2) is deformed until the annular extreme outer surface of 34 comes into contact with the flat annular grooved surface 24 of connector fitting 20. In FIG. 3D-3E, first tube 11 and second tube 16 are joined by connector fitting 20. Annular bosses 34 formed in the tubes 11, and/or 16 by the swaging tool 10 (see FIGS. 1 and 2) is deformed until the annular extreme outer surface of 34 comes close but does not make contact with the flat annular grooved surface 24 of connector fitting 20.The annular grooves 24 are square cut and have outer 90 degree radial corners 27. These outer 90 degree edges 27 retain the swaged tubes 11 and/or 16 in place. The outer 90 degree edge 27 allows the annular boss 34 to bear up against it, but will not let the swaged tube pass beyond. Extreme tensile forces will need to be applied in order for the swage assembly to separate. It is reasonable to deduct that the swaged tube would shear at the point of the annular boss 34 location if enough tensile force is applied. In FIG. 3A-3B, there are 2voids 32 between each side of the annular grooves 24 of the connector fitting 20 and the annular bosses 34 of the tube 16 (and 11 as well). In FIGS. 3D-3E, there are 2voids 32 between each side of the annular grooves 24 of the connector fitting 20 and the annular bosses 34 of the tube 11 and or 16. There is an additional gap 35 between the flat of the annular groove 24 and the annular boss 34 that joins both voids 32. The space can be empty, filled with grease or other suitable compounds to maximize rotational movement between tubes 11, 16, and connector fitting 20 or filled with silicone or other suitable compounds to minimize rotational movement between tubes 11, 16 and connector fitting 20 and can help promote a watertight swage assembly. Gap 31 exists between connection fitting 20 and tubes 11 and/or 16. This gap 31 is designed to assist with the free rotation of the swage tube assembly. Both ends of the connector body have edges 28 that are used for assisting in the placement of the swaging tools 10 or 60. The tubes 11 and 16 are now mechanically engaged with the connector fitting 20, forming a mechanically stable joint with a continuous communicable space.

Benefits of the annular grooves 24 being square cut are numerous, and include: (a) minimal surface contact between the radius of the annular boss 34 of the swaged outside tube 11, 16 and the inside diameter surface of the square cut annular groove 24. This allows the swaged tube 11, 16 to freely rotate as desired. The outer tube 11, 16 would then become a hinge joint in certain applications.

(b) the outer 90 degree edge feature 27 of the square cut provides a positive limitation to the assembly and maintains a positive locking feature to the assembly. A significant tension force would need to occur in order to separate the assembly. The outer 90 degree edges of the annular grooves 24 would dig into the side of the inner annular boss 34 of the tubes 11, 16 and eventually shear the outer tube 11 and/or 16before separation of the assembly.
(c) Grease or other suitable compound can be applied liberally around the inside of the square cut annular groove 24 and the outside surfaces of ends 21 and or 26 prior to assemblage of tubes 11 and or 16. This application will ensure there will be sufficient anti-friction material between annular boss 34 and the outer tube 11, 16 and connector fitting 20 to further ease rotation-ability of the swage assembly.
(d) silicone or other suitable compound can be applied liberally around the inside of the square cut annular groove 24 and the outside surfaces of ends 21 and or 26 prior to assemblage of tubes 11 and or 16. This application will ensure there will be sufficient resistance between annular boss 34 and the outer tube 11, 16 and connector fitting 20 to further restrict the rotation-ability of the swage assembly.
(e) a strong joint connection is made without the need for any fasteners. Extreme tension between both swaged joints 11-20 and 16-20 would need to be applied before they would separate. If the tubes 11 and/or 16 were constrained, the connection joint 20 of the swaged assembly would be free to rotate and act as a hinge in certain applications.

FIG. 4 shows details of the swaging tool 10 and connection. In this figure, connector fitting 40 is formed at a right angle, allowing a 90 degree feature in the connection between first tube 11 and second tube 16. This could be done by machining rod fittings and welding them together, casting/forging the connector fitting 40 in this shape, or making it of a material flexible enough to allow the bending as the tubes 11 and 16 are put in place. Swage head 15 is engaged with tubes 11 and 16 and has completed the swaging of annular bosses 34, which are engaged with annular grooves 24. In this embodiment, the annular bosses 34 can be swaged in place, with the distance between support wheels 17 and swaging wheel 18 being reduced until the outer radial surface of annular boss 34 makes contact or nearly makes contact with annular groove 24 surface.

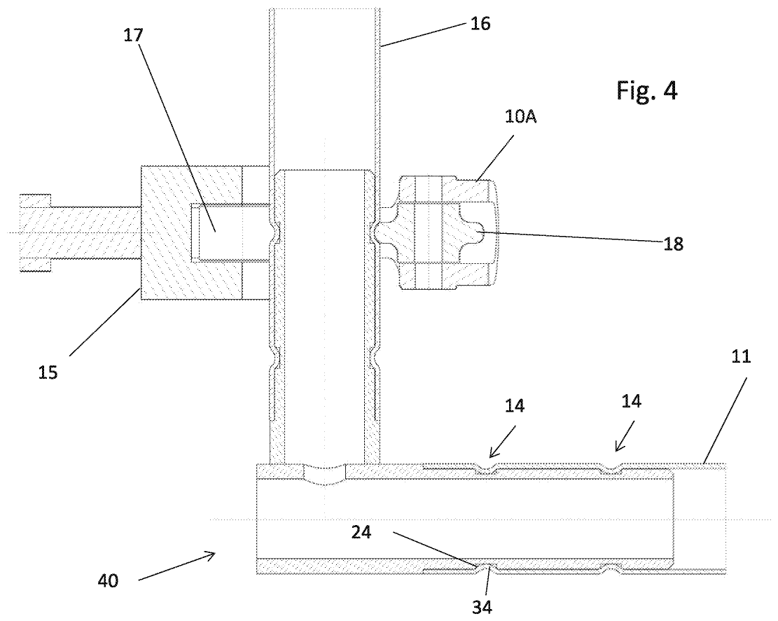

FIG. 5A shows a top view of the swaging tool 10 in a swaging configuration, and FIG. 5B shows a side view of a cutting tool 10A in a cutting configuration. This is an optional embodiment which increases the utility of the swaging tool. In configuration 10, the swaging tool 10 includes support wheels 17and swaging wheel 18. In configuration 10A, the cutting tool has a swaging wheel 18 replaced with cutting wheel 58 (related art). Cutting wheel 58 has a sharp knife edge and when configuration 10A is rolled around the tube, it will cut the tube instead of swaging the swaging rings. Wheel retaining pin 52 is removable and allows the efficient exchange of the swaging wheel with the cutting wheel.

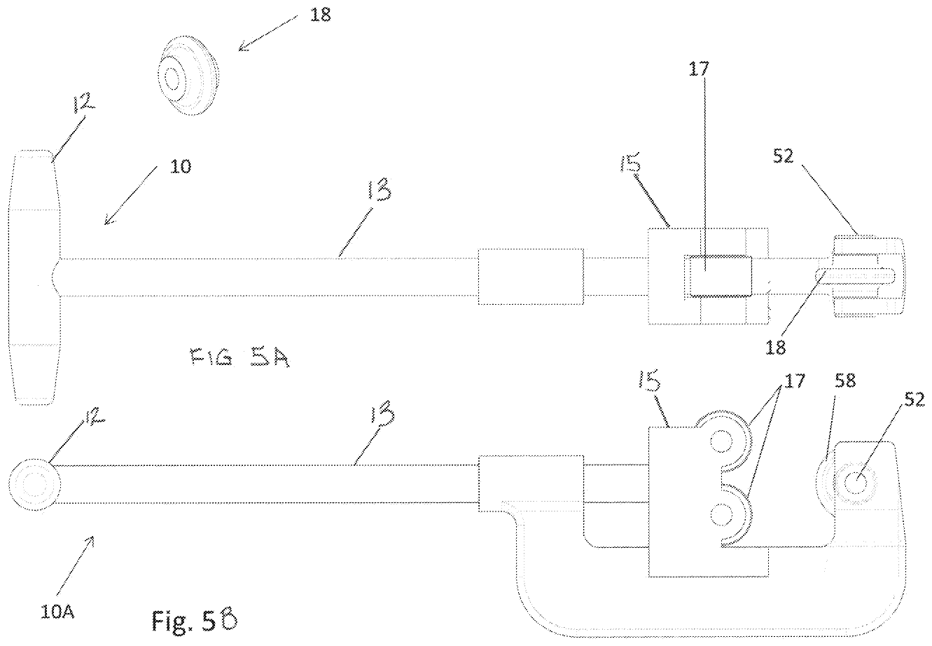

FIG. 6 shows a first optional variant on the invention wherein a swaging tool 60 has swaging head 65, which is comprised of a set of support wheels 67A and 67B, and a set of swaging wheels 68A and 68B. The set of support wheels 67A, 67B and swaging wheels 68A, 68B are offset by a fixed amount corresponding to the distance between annular grooves 24 (not shown, see FIG. 2) such that the tube 11 and/or 16 will engage with both annular grooves. It is optional to allow the distance between the swaging wheels 68A and 68Band support wheels 67A and 67B to be adjustable by the user such that the swaging tool 60 can be used with different configurations of connector fittings and tube sizes. Optional spacer plates 62A and 62B mounted on either side of swaging head 65 provide correct placement of swaging wheels 68A and 68B and support wheels 67A and 67B with respect to the connector fitting containing dual annular groove 24 positions (not shown, see FIG. 4).

It is optional to include even more swaging wheels and/or support wheels, or to apply the swaging tool 60 to the tubes 11, 16 multiple times to provide additional annular bosses corresponding to the square cut annular grooves 24 in the connector fitting 20. This could provide additional mechanical integrity to the joint and/or allow multiple configurations of the joint.

FIG. 7B shows a cross-sectional view including swage tool 60 and FIG. 7A is a side view of a second optional improvement wherein a connector fitting 70 has O-ring groove 72 into which O-ring71 can be inserted. This increases the integrity of the joint, helping to keep moisture and air out and any fluids transmitted by the tubes 11 and 16 in for certain applications. Additionally, silicone or other suitable compound can be applied liberally around the inside of the square cut annular groove 24 and the outside surfaces of ends 21 and or 26 prior to assemblage of tubes 11 and or 16 to further increase the integrity of the joint to help keep moisture and air out and any fluids transmitted by the tubes 11 and 16 in for certain applications.

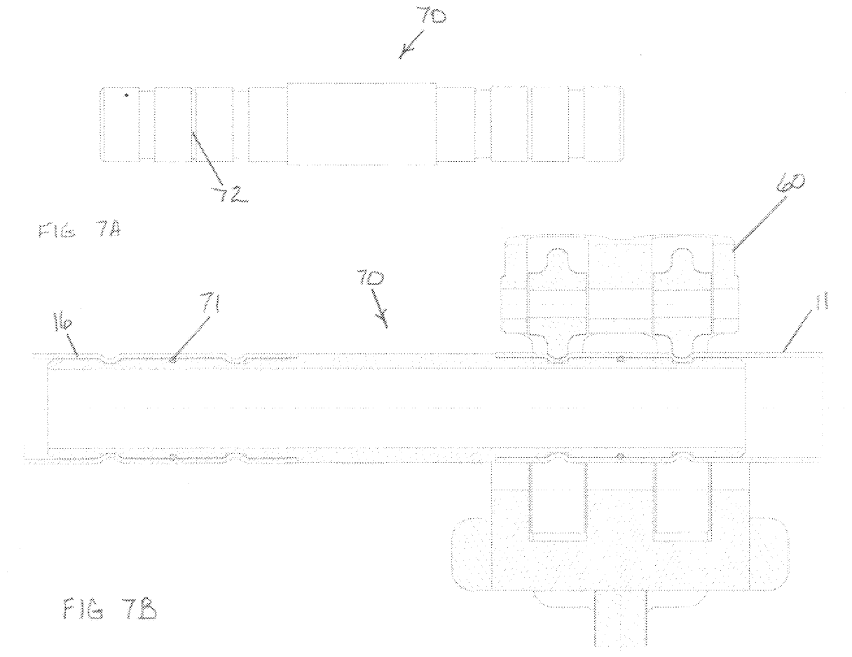

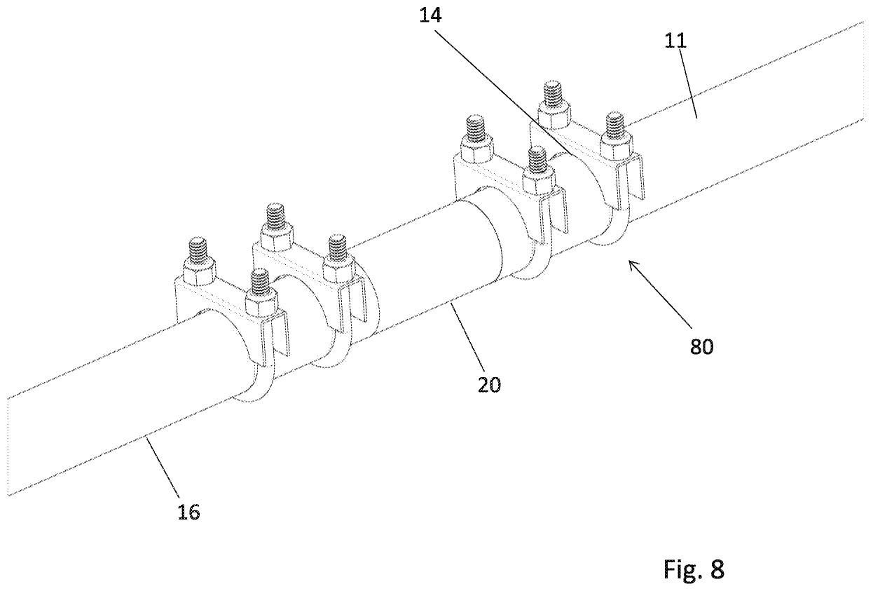

FIG. 8 shows a third optional variant on the invention wherein the joint is further secured with exterior clamps 80. While the use of exterior clamps 80 to secure tube joints is known in the art, the invention's provision of swaged rings 14 make the use of such clamps much more effective with additional option to the application of silicone or other similar compounds to increase rigidity between tubes 11 and or 16 and connector 20. An additional element added to such clamps further increases their efficiency as shown in FIG. 9. Clamps 80 are fitted into swaged rings 14 such that they engage the reduced outside diameter of the tubes 11 and 16, keeping them straight and in a fixed position on the tube. In FIG. 9, it can be seen that clamp 80 is a U-bolt 92 with a saddle bracket 94, secured by nuts 91. Interior member 93 fits into swaged ring 14 and provides for the equal distribution of clamping force on the outside diameter of the tubes 11 and 16, making the engagement of the annular boss and the annular groove solid and uniform.

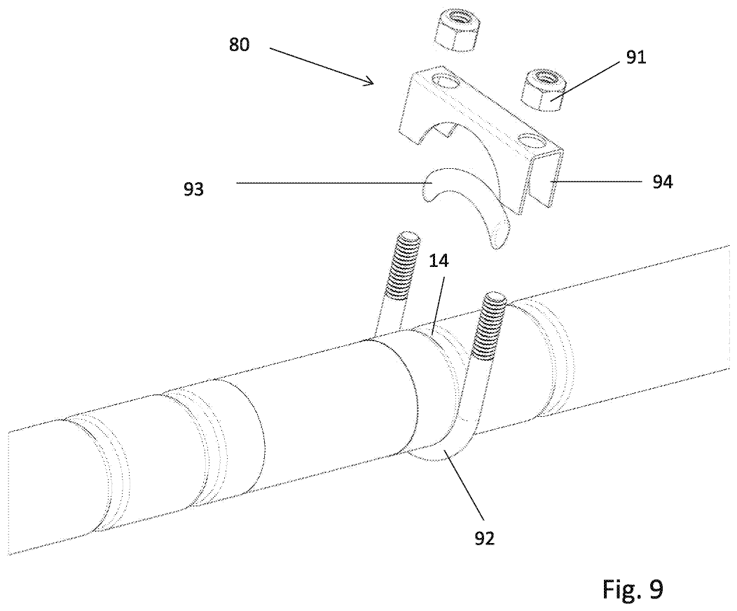

FIGS. 10A and 10B show two different perspective views of a fourth optional variant on the invention wherein connector fitting 100 includes shoulders 25. Shoulders 25 are equal to or larger than the outside diameter of the tubes to be joined (not shown) and serve to both improve the seal between the tubes to be joined and connector fitting 100 and to provide for a fixed placement of the tubes 11 and 16 onto all connector fittings.

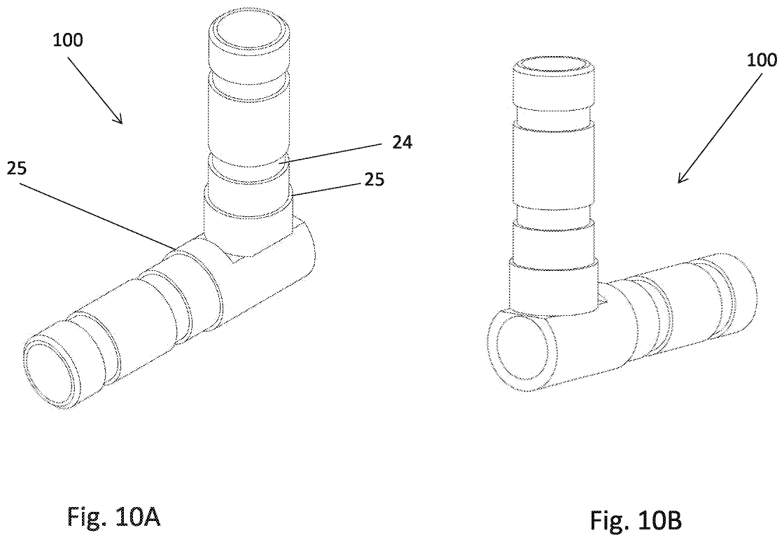

FIGS. 11A and 11B show a fifth optional variant on the invention wherein connector fitting 110 includes shoulder 25 (see FIG. 10) and threaded end 112. This allows the tube with which connector fitting 110 is engaged (not shown) to be attached to a threaded receiver such as a pre-threaded tube (not shown,) or a fixed threaded flange 111. This is a particularly advantageous application of the invention as only connector fitting 110 needs to be rotated/threaded into the receiver instead of the entire length of the tube after the connector fitting 110 has been swaged to tube 11 or 16.The threads of connector fitting 110 can be engaged into the threaded receiver or removed from the threaded receiver after the connector fitting has been swaged to tube 11 or 16. FIGS. 11C and 11D show a sixth optional variant on the invention wherein connector fitting 110 includes shoulder 25 (see FIG. 10) and threaded end 112 swaged onto tube 11 or 16 wherein connector fitting 110 can be freely rotated independently from tube 11 or 16 after swaging and threaded end 112 threads (freely screws) into or out from threads 114 of threaded fitting 113. FIG. 11C shows before installation and FIG. 11D shows after installation. Fitting 110 may have flats on the exposed body above the threads (not shown) for wrenching.

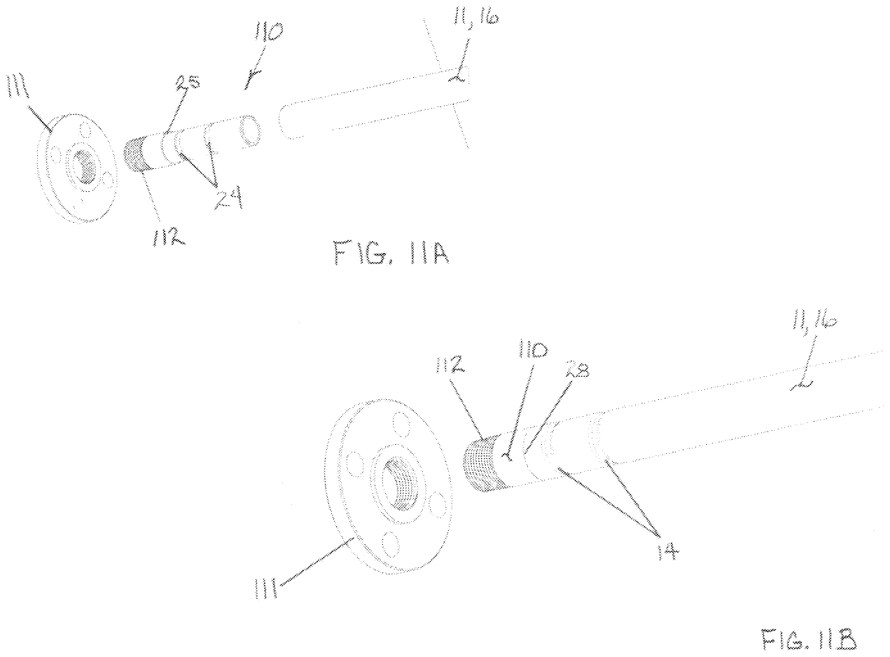

FIGS. 12A and 12B show a seventh optional variant on the invention wherein connector fitting 120 has hinge boss 133, to which second connector fitting 128 can be movably connected via bolt 135 and nut 137. FIG. 12B shows the second connector fitting 128 detached from the hinge boss 133.

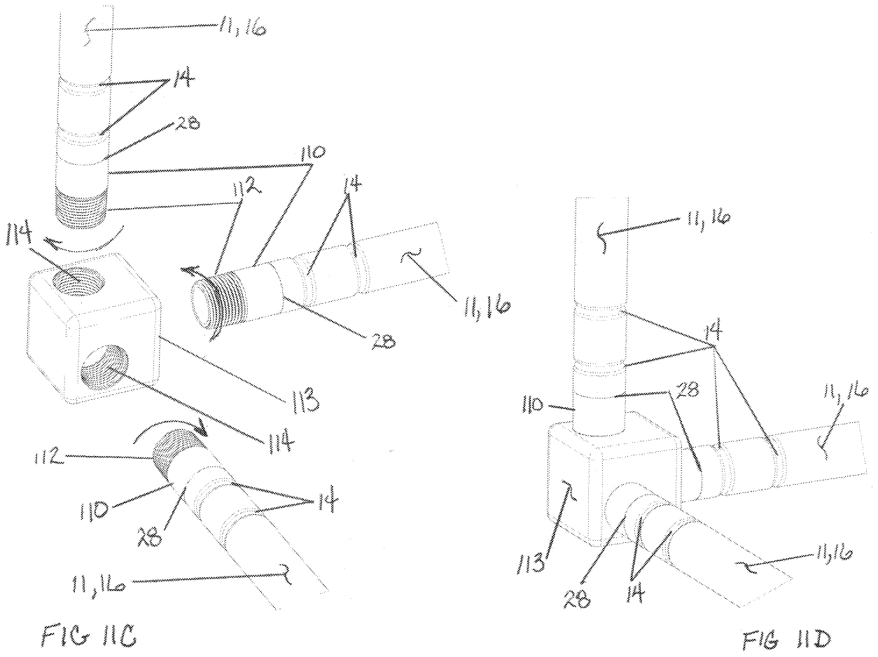

FIGS. 13A-13D show an eighth optional variant on the invention wherein flange 134 surrounds a portion of connector fitting 130, allowing it and the entire assembly to be affixed to a surface with screws, nails, bolts, or any other suitable means. It is preferred, but not required, that connector fitting 130 be welded or otherwise permanently affixed to flange 134.

If it is not desired that the assembly be allowed to rotate at all with respect to flange 134, as an addition or alternative to welding, optional through holes 138 can be used to affix the connecting member to the flange. Optional through holes 138 can also be used to mount flange 134 to an underlying surface, either by drilling flange 134 at the time of assembly or incorporating corresponding holes at an earlier time.

In another variant, a flange feature 134 may not be suitable or sufficient for a particular application. As shown in FIG. 13E, optional flat feature 132 can be applied to one or both sides of connector fitting 130 and one or more through holes 138 added allowing the entire assembly to be affixed to a flat surface or between two flat surfaces with screws, nails, bolts, or any other suitable means.

If the connector fitting 130 is desired to be rotatable with or without flanges 134 or holes 138, the communicable joint tubes would simply be fixed/restrained in position. This would allow the connector fitting to be free to rotate.

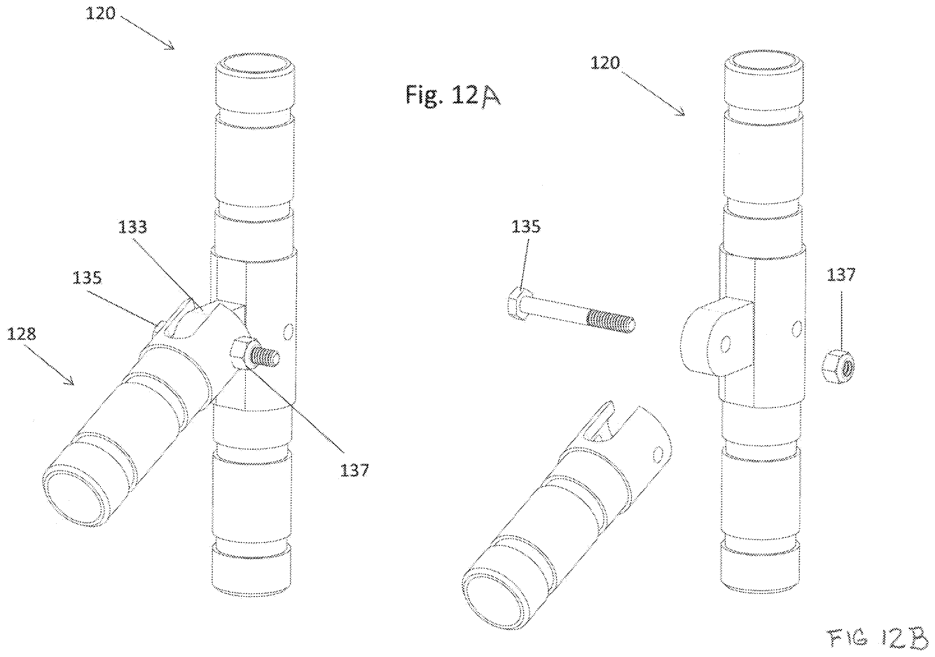

FIG. 14 shows a ninth optional variant on the invention wherein connector fitting 140 has multiple connector ends 142a, 142b, and 142c, and a threaded end 144, which allows multiple tubes (not shown, see previous figures) to be connected to a tube, member, or other fitting which has a threaded receiver.

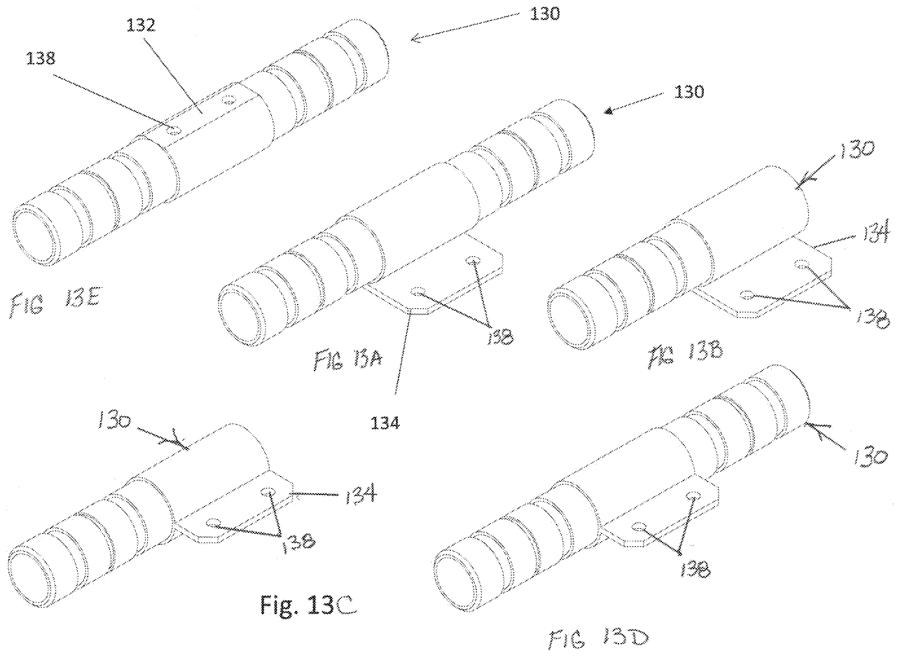

FIG. 15 shows a tenth optional variant of the invention wherein connector fitting 150 has a connector end 152 and a saddle end 154. Saddle end 154 has a through-hole which allows saddle bolt 156 to be secured with saddle nut 158 and hold saddle bracket 159. Optional rebate 151 in saddle end 154 is shaped to provide full clearance of the tube or other round item which passes through saddle bracket 159 no matter what angle the saddle bracket 159 is at in respect to saddle end 154.

FIG. 16 shows an eleventh optional variant on the invention wherein connector fitting 160 has a chamfered inner surface 161 at one or both ends of connector fitting 160. This makes it easier for whatever is to be passed through tube 16 and thus through connector fitting 160 to pass through the joint. In particular, this reduces wear on insulated cables or interior conductors of whatever type as they pass through the joint and/or as the joint may move or flex and/or the interior conductors may move or flex.

An optional variant (not shown) applicable to many of the embodiments described would be to add a compound comprising adhesive sealant (or having the properties of either adhesive or sealant) to the annular grooves of a connector fitting. This would, depending on whether the compound was adhesive, sealant, or both, improve the mechanical and/or fluid retention properties of the completed assembly.

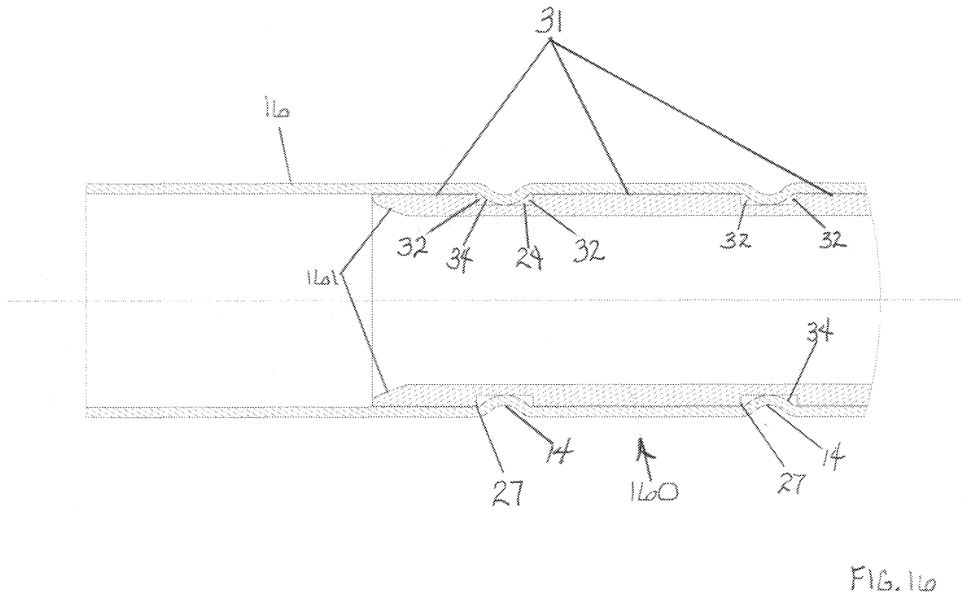

FIG. 17 shows a twelfth optional variant on the invention wherein an assembly 1700 is comprised of a single tube 1701 that has been formed to include 5 straight line tube segments and 4 curved shape corners in a rectangle or square shape with a gap between both ends of tube 1701. Each end has been swaged with a connector fitting 1706. Each connector fitting is mounted with flange 1702 (or any other suitable mounting) according to the manner of the invention Assembly 1700 has exterior swaged annular rings 14 on the outside of the 1701formed tube which match the interior swaged annular bosses on the inside of 1701 formed tube opposing square cut annular grooves on the 1703 connector fittings (Not shown, see FIG. 2, square cut annular grooves 24 and annular bosses 34) for an analogous configuration) of connector fitting 1703 which is retained on a surface by mounting flange 1702. When tube 1701 is assembled as shown onto connector fitting 1703 until its annular grooves engage the annular bosses of connector fitting1703, tube 1701 is engaged, retaining assembly 1700, shown as assembly 1700A in a raised position and assembly 1700B in a lowered position. Grease or other suitable compound can be applied liberally around the entire area of both square cut grooves 24 and around the entire outside surfaces of ends 21 and or 26 of connector fitting 1703 prior to assemblage of tube 1701 before swaging to decrease the level of friction and allow the 1700 assembly to rotate freely.

It is preferred, but not required, that tube 1701 be made of a single tube bent to the proper dimensions with a tube bending tool such as a conduit bender. If tube 1701 is not a single piece, the method of the invention can also be applied to the assembly 1701, allowing it to be assembled from multiple tubes but with increased integrity over mere insertion of smaller ends into larger ends or other methods known in the prior art.

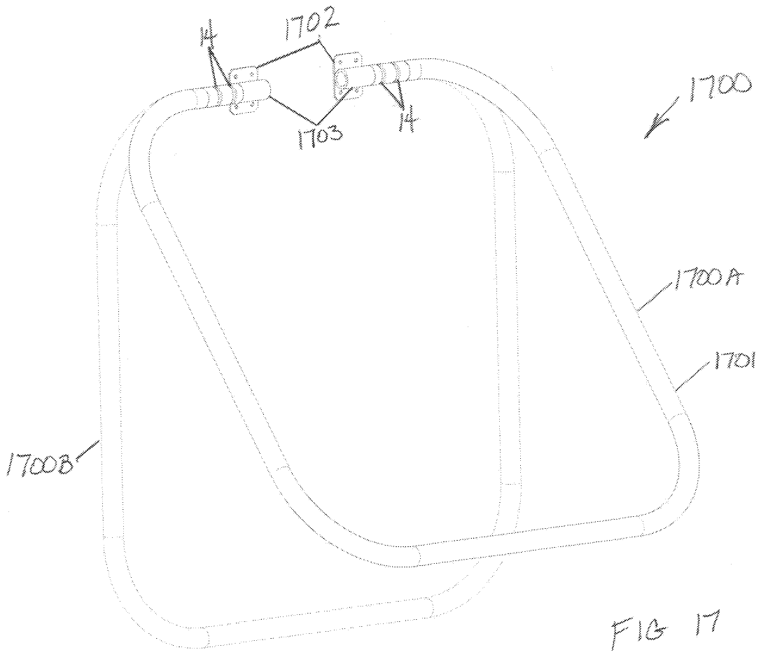

FIG. 18 shows a first assembly 1800 incorporating a process and system of the invention. Assembly 1800 is comprised of rotatable swaged tubes1801, 1803, 1806, 1807, 1808, 1809, and 1811-1822, and connectors 1805 and 1810.Connectors 1805 and 1810 connect with rotatable swaged tubes via swaged rings 14. (See FIG. 2 for details of the annular grooves and bosses used by the process and system of the invention.) Assembly 1800 becomes movable due to the addition of casters 1802, which are inserted in connectors1805. As will be shown below, the process and system of the invention allows moveable assembly 1800 to be customizable in all dimensions without sacrificing structural integrity or requiring additional structural elements other than those of the process and system of the invention. Here, each rotatable swaged tube 1801,1803, 1804, 1806, 1807, 1808, 1809, and 1811-1822 becomes a potential rotatable hinge member. The configurations are only limited to design requirements as needed.

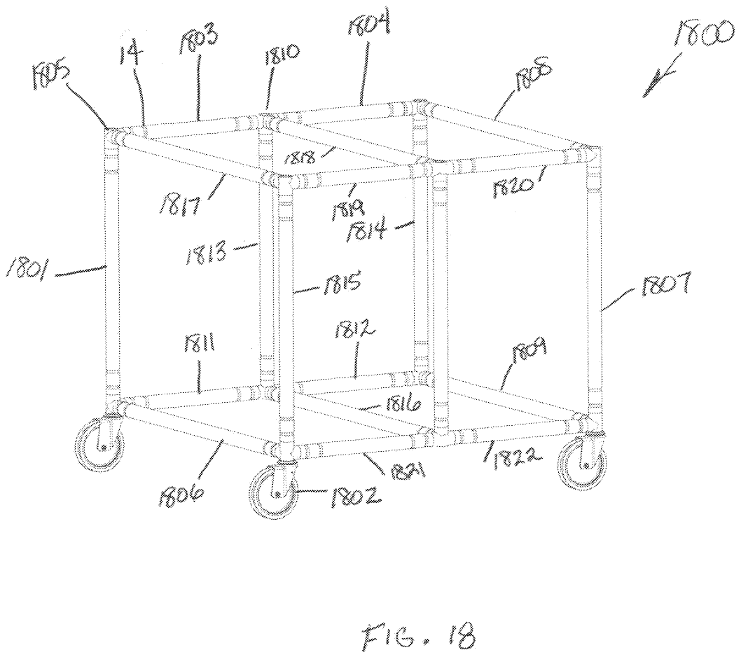

FIG. 19 shows a second assembly 1900 incorporating a process and system of the invention. Shelving elements 1901, 1902, and 1903 have been added. Removable retaining elements 1904 are used to affix shelving units 1901, 1902, and 1903 to the assembly 1900.

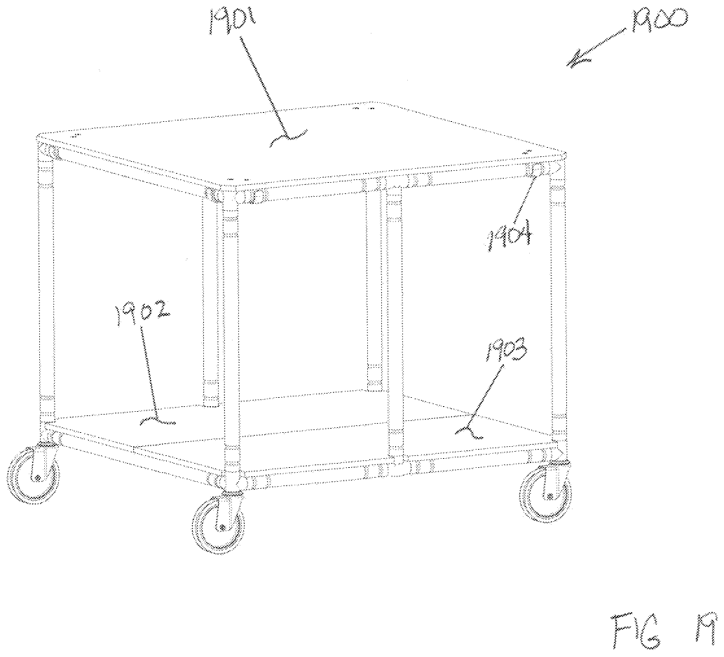

FIG. 20 shows a third assembly 2000 incorporating a process and system of the invention. Wall elements 2001, 2002, and 2003 have been added and have removable retaining elements affixed as in FIG. 19.

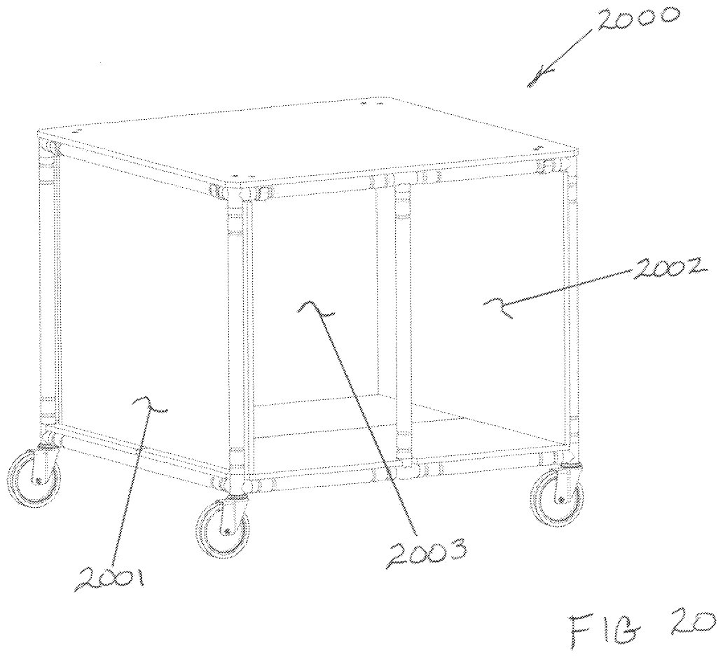

FIG. 21 shows a fourth assembly 2100 incorporating a process and system of the invention. Foldable tow bar 2101, shown as foldable tow bar 2101(a) in a retracted position and as foldable tow bar 2101(b) in an extended position allows the assembly to be towed when desired and can be retracted for convenience when not in use. Foldable tow bar 2101 is fashioned from tubes 2102 connected with connectors 2103 in the manner of the system and process of the invention, and can retract or extend with the rotation of rotatable swaged tube 1806.Optional tow hitch 2105implemented when it is desired to move the moveable assembly 2100 with a tow vehicle (not shown) which uses a hitch system.

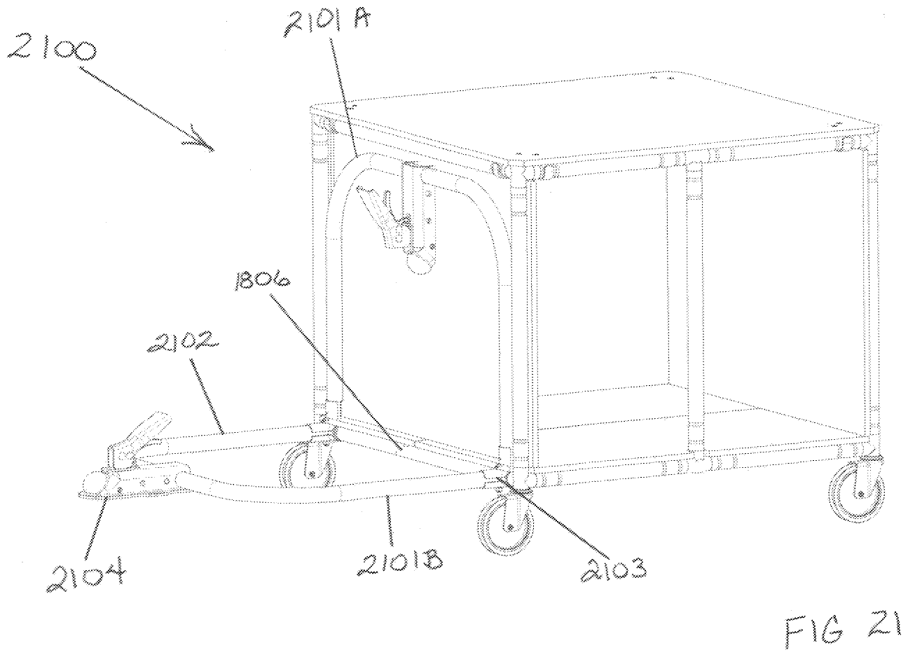

FIG. 22 shows a fifth assembly 2200 incorporating a process and system of the invention. Door support elements 2201 are fashioned in the manner and process of the invention to support door elements 2202, which can open and close with the rotation of rotatable swaged tube 1807.

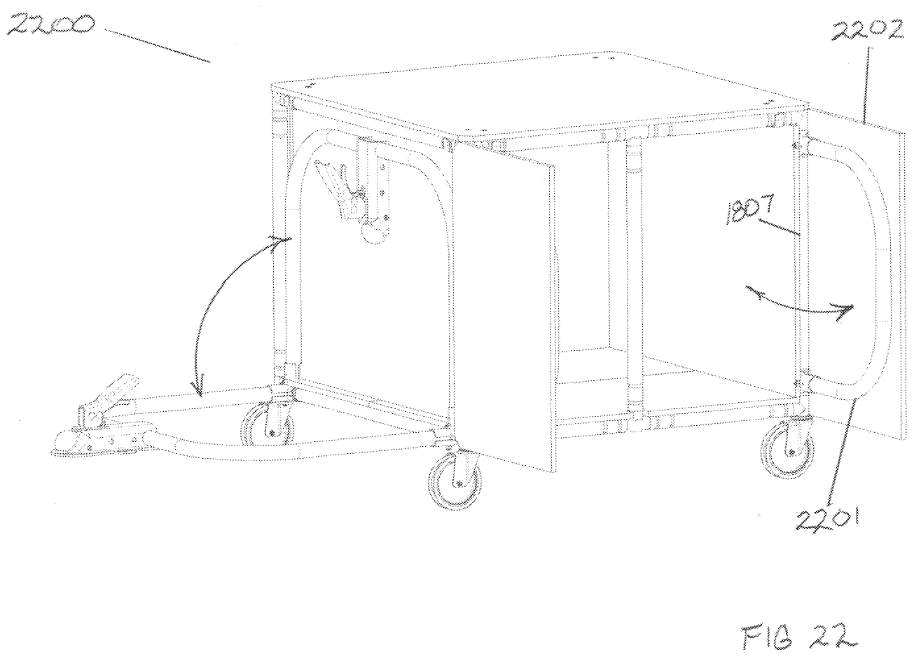

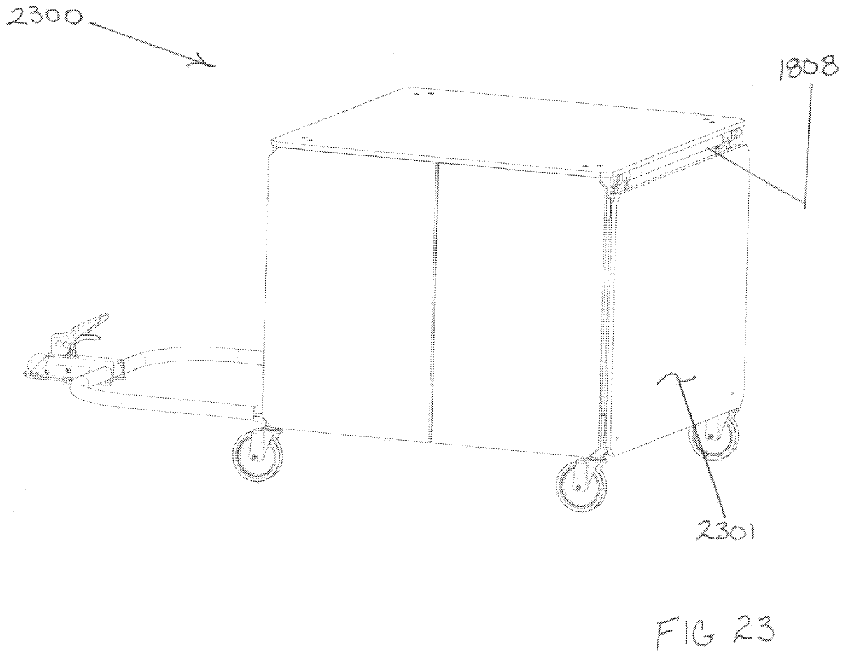

FIG. 23 shows a sixth assembly 2300 incorporating a process and system of the invention. Table element 2301 is irremovably affixed to table support 2403 (not shown, see FIG. 24). Rotatable swaged tube 1808 allows table support 2403 to raise and lower and thus either hold table element 2301 in a retracted position for convenience or in an extended position (see FIG. 24)

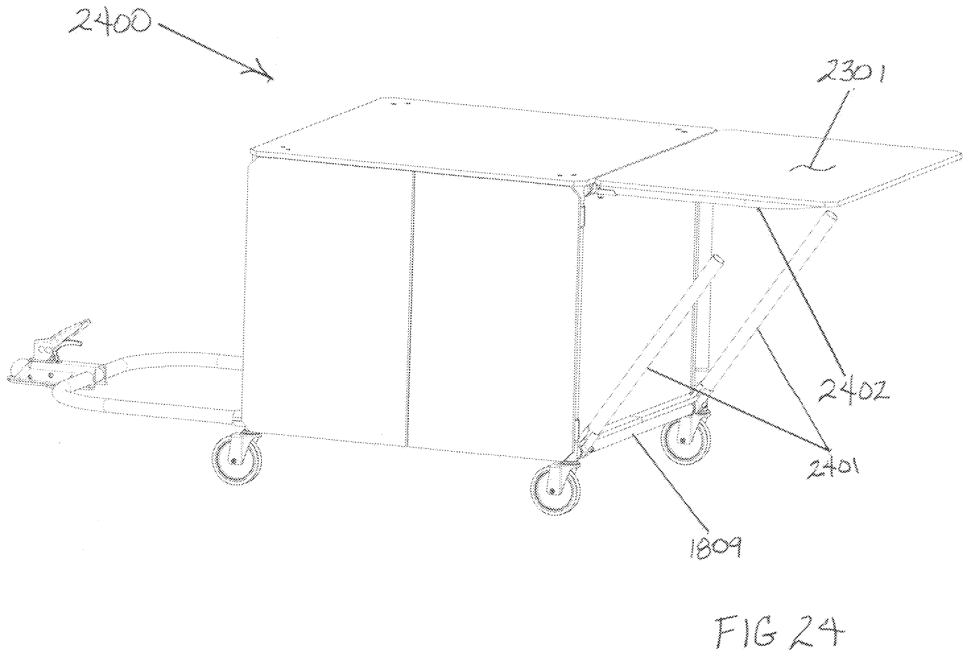

FIG. 24 shows a first alternate configuration 2400 of the sixth assembly incorporating a process and system of the invention. In this configuration rotatable swaged tube 1808 (not shown, see FIG. 23) has rotated to allow table support 2403 to hold table element 2301 in the extended position. Struts 2401 are used to receive strut fittings 2501 (not shown—see FIG. 25) that will be used to brace table support element 2403, and are currently in an extended position made possible by the rotation of rotatable swaged tube 1809.Table support element 2403 and struts 2401 are fashioned in the manner and process of the invention to support table element 2301.

FIG. 25 shows the same alternate configuration 2400of the sixth assembly incorporating a process and system of the invention. Strut fittings 2501, allow a simple and structurally sound way to secure struts 2401 to table support element 2403.

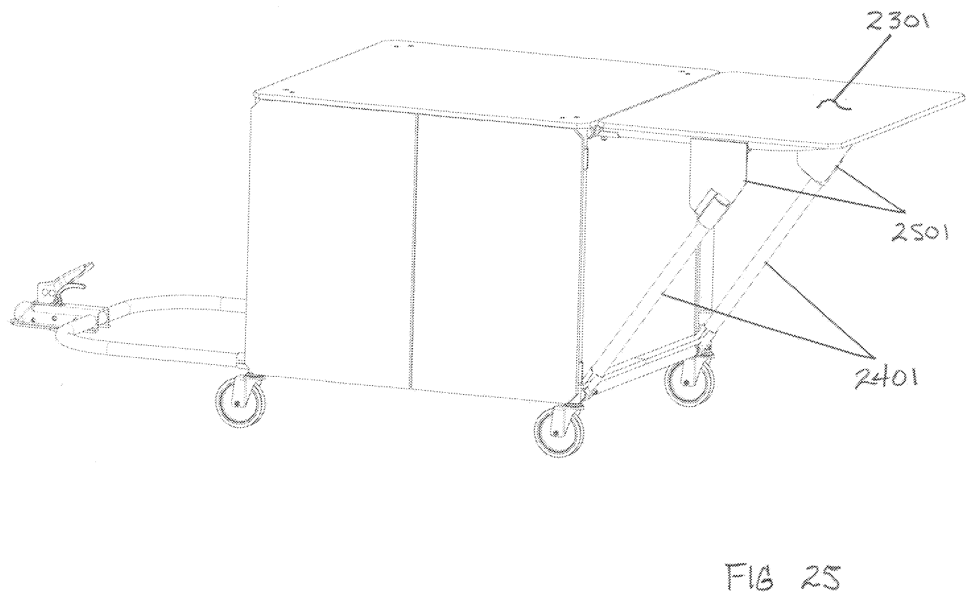

FIG. 26 shows a structural configuration of the same alternate configuration of the sixth assembly incorporating a process and system of the invention. Table support element 2403 and its interaction with strut fittings 2501 and rotatable swaged tube 1808, and likewise the interaction of struts 2401 with rotatable swaged tube 1809.

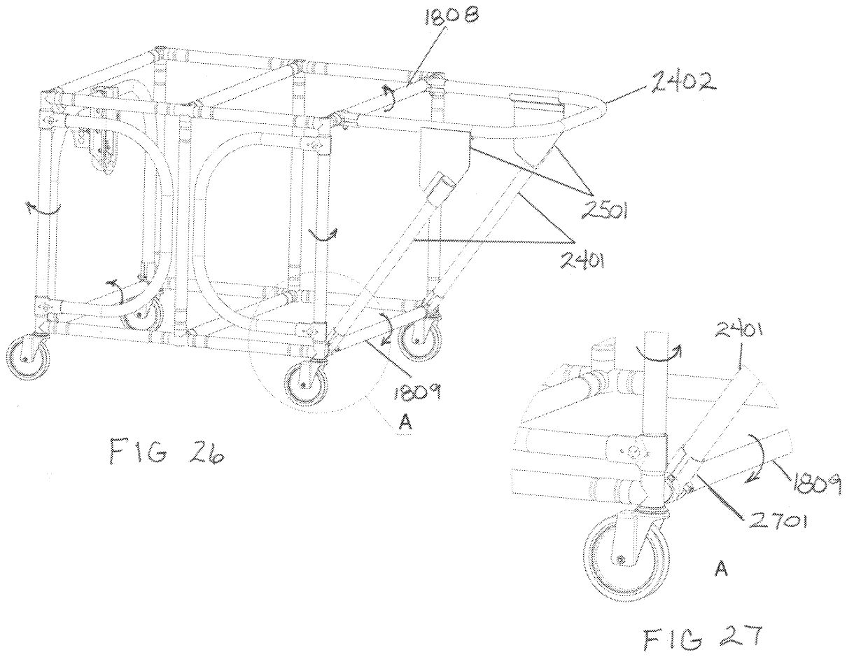

FIG. 27 shows a detail common to several of the above-described assemblies incorporating a process and system of the invention. Tube clamp 2701 secures strut 2401 to rotatable swaged tube 1809. Because it is rotatable swaged tube 1809 which rotates, both struts 2401 must rotate exactly the same amount at any given time, preventing the elements which are rotating from skewing or twisting and maintaining the fixed geometry of the hinge created by the method and process of the invention without additional or ongoing maintenance and adjustment.

It will be apparent to those of ordinary skill in the art that the variants detailed above may be combined as desired to further improve the applicability of the invention to any given application, including the control of cost and complexity and the required level of mechanical reliability of a particular application.

This application—taken as a whole with the abstract, specification, and drawings being combined—provides sufficient information for a person having ordinary skill in the art to practice the invention as disclosed herein. Any measures necessary to practice this invention are well within the skill of a person having ordinary skill in this art after that person has made a careful study of this disclosure.

Because of this disclosure and solely because of this disclosure, modification of this device and method can become clear to a person having ordinary skill in this particular art. Such modifications are clearly covered by this disclosure.

What is claimed is:

1. A tube swage system comprising:
a first tube having a first outer wall and a first annular boss extending from a first inner wall of the first tube; and
a connector fitting having a first annular square cut groove with 90 degree square edges, the first annular square cut groove mechanically engaging with the first annular boss, wherein voids are formed between parts of a surface of the first annular boss and parts of a surface of the first annular square cut groove.

2. The tube swage system according to claim 1, wherein the voids contain air.

3. The tube swage system according to claim 1, wherein the voids contain a compound including a lubricant or a sealant.

4. The tube swage system according to claim 1, wherein the first annular boss has a different shape from the first annular square cut groove.

5. The tube swage system according to claim 1, wherein the 90 square cut edges provide limits to the amount the first tube moves axially in relation to the connector fitting.

6. The tube swage system according to claim 1, wherein there are gaps between the first tube and the connector fitting adjacent to the first annual square cut groove and the first annular boss in a circumferential direction of the first tube and the connector fitting.

7. The tube swage system according to claim 6, wherein the gaps are air gaps.

8. The tube swage system according to claim 1, wherein the gaps contain a compound including a lubricant or a sealant.

9. The tube swage system according to claim 1, wherein a bottom surface of the first annular boss is in contact with a bottom surface of the first annular square cut groove in a center region of the first annular square cut groove.

10. The tube swage system according to claim 1, wherein there is a second gap between a bottom surface of the first annular boss and a bottom surface of the first annular square cut groove in a center region of the first annular square cut groove, wherein the second gap joins the voids.

11. The tube swage system according to claim 10, wherein the voids and the second gap contain air.

12. The tube swage system according to claim 10, wherein the voids and the second gap contain a compound including a lubricant or a sealant.

13. The tube swaging system according to claim 1, further comprising:
a clamp;
wherein the connector fitting further comprises swaged ring grooves into which the clamp is fitted to increase rigidity between the first tube and the connector fitting.

14. The tube swaging system according to claim 1, further comprising:
a second connector fitting;
wherein the connector fitting has a hinge boss to which the second connector fitting is irremovable and/or rotatably connected.

15. The tube swage system according to claim 1, further comprising:
a second tube having a second outer wall and a second annular boss extending from a second inner wall of the second tube;
wherein the connector fitting has a second annular square cut groove with 90 degree square edges at a first end of the connector fitting opposite a second end of the connector fitting where the first annular square cut groove is mechanically engaged with the first annular boss, the second annular square cut groove mechanically engaging with the second annular boss, wherein second voids are formed between parts of a surface of the second annular boss and parts of a surface of the second annular square cut groove.

16. The tube swage system according to claim 3, wherein the compound contains the lubricant, and the first tube is freely rotatable on the connector fitting while the first tube remains engaged with the connector fitting.

17. The tube swage system according to claim 3, wherein the compound contains the sealant, and the first tube is not rotatable relative to the connector fitting.

18. The tube swage system according to claim 1, wherein the connector fitting has an outer body with a shoulder having an outer 90 degree corner to define edge curves usable for reference when positioning a swaging tool.

19. The tube swage assembly according to claim 1, further comprising:
a threaded fitting with threads;
wherein
the connector fitting has a threaded end opposite to an end to which the connector is engaged with the first tube (swaged);
the threaded end of the connector fitting threadable with the threaded fitting so as to enable the connector fitting to be able to freely screw into and unscrew from the threads of the threaded fitting (after swaging).

20. The tube swage assembly according to claim 15, further comprising:
a threaded fitting with a first and second threads;
wherein
the connector fitting has a first threaded end opposite to an end to which the connector fitting is engaged with the first tube (swaged);
the second connector fitting has a second threaded end opposite to an end to which the second connector fitting is engaged with the second tube (swaged); and
the threaded end of the connector fitting threadable with the threaded fitting so as to enable the connector fitting to be able to freely screw into and unscrew from the first threads of the threaded fitting (after swaging); and
the threaded end of the second connector fitting threadable with the threaded fitting so as to enable the connector fitting to be able to freely screw into and unscrew from the second threads of the threaded fitting (after swaging).

21. An assembly comprising:
a plurality of tubes each having an outer wall and an annular boss extending from an inner wall of the tube; and
a plurality of connector fittings each having an annular square cut groove with 90 degree square edges;
wherein the square cut groove of each of the plurality of connector fittings mechanically engages with the annular boss of one of the plurality of tubes; wherein voids are formed between parts of a surface of each annular boss and parts of a surface of a corresponding one of the annular square cut grooves.

22. The assembly according to claim 21, wherein:
wherein a bottom surface of each of the annular bosses is in contact with a bottom surface of the corresponding annular square cut groove in a center region of the annular square cut groove.

23. The assembly according to claim 21, wherein there is a second gap between a bottom surface of each of the annular grooves and a bottom surface of the corresponding annular square cut groove in a center region of the annular square cut groove, wherein the second gap joins the voids.

24. The tube swage system for connecting tubes according to claim 21, wherein ones of the tubes are rotatable relative to the corresponding connector fitting and other ones of the tubes are not rotatable relative to the corresponding connector fitting.
